(19) United States
(12) Patent Application Publication
(10) Pub. No.: US 2004/0182769 A1
(43) Pub. Date: Sep. 23, 2004

(54) Multi-chamber magnetic filter

(76) Inventors: Richard Edward Fogel, Lake Orion, MI (US); Steven Willam French, Howell, MI (US)

Correspondence Address: HARNESS, DICKEY & PIERCE, P.L.C., P.O. BOX 828, BLOOMFIELD HILLS, MI, 48303, US

(21) Appl. No.: 10/805,508

(22) Filed: Mar. 19, 2004

Related U.S. Application Data
(60) Provisional application No. 60/455,831, filed on Mar. 19, 2003.

(51) Int. Cl. B01D 35/06

(52) U.S. Cl. 210/222

(57) ABSTRACT

A multi-chamber magnetic filter is disclosed. The filter incorporates tubes that extend through a plurality of chambers that can contain a fluid to be filtered. Magnet assemblies are shuttled through the tubes and can be positioned within a chamber for use in removing ferromagnetic particles from a fluid flowing therethrough. Accumulated ferromagnetic materials can be readily purged from a chamber that does not have magnet assemblies located therein.

### CROSS-REFERENCE TO RELATED APPLICATIONS

This application claims the benefit of U.S. Provisional Application No. 60/455,831, filed on Mar. 19, 2003. The disclosure of the above application is incorporated herein by reference.

### FIELD OF THE INVENTION

The present invention relates generally to magnetic filters, and more specifically to multi-chamber magnetic filters for cutting oil that incorporate a backwash feature.

### SUMMARY OF THE INVENTION

The present invention is directed to a multi-chamber magnetic filter. In one preferred form, the present invention provides a multi-chamber magnetic filter including a first chamber, a second chamber, a filter tube interposed at least partially through the first and second chambers and a magnetic assembly interposed within the filter tube and adapted for movement therein so as to be positioned within the first and second chambers.

In another aspect, the present invention provides a method whereby a multi-chamber magnetic filter is adapted for filtering a working fluid within a first chamber. In yet another aspect of the present invention, provides a method whereby a multi-chamber magnetic filter is adapted for backwashing a filtered media from a first chamber.

In a further aspect the present invention provides a method whereby a multi-chamber magnetic filter is adapted for simultaneously filtering a working fluid within a first chamber and backwashing a filter media from a second chamber.

### BRIEF DESCRIPTION OF THE DRAWINGS

The present invention will become more fully understood from the detailed description and the accompanying drawings, wherein:

FIG. 1 is a partial cut away side view of the magnetic filter of the present invention;

FIG. 2 is a top view of the magnetic filter of FIG. 1;

FIG. 3 is an exploded side view of the magnetic filter of FIG. 1;

FIG. 4 is a side view of a magnetic assembly particularly suited for the magnetic filter of FIG. 1; and

FIG. 5 is a piping schematic for the magnetic filter of FIG. 1.

### DETAILED DESCRIPTION OF THE PREFERRED EMBODIMENTS

The following description of the preferred embodiment(s) is merely exemplary in nature and is in no way intended to limit the invention, its application, or uses.

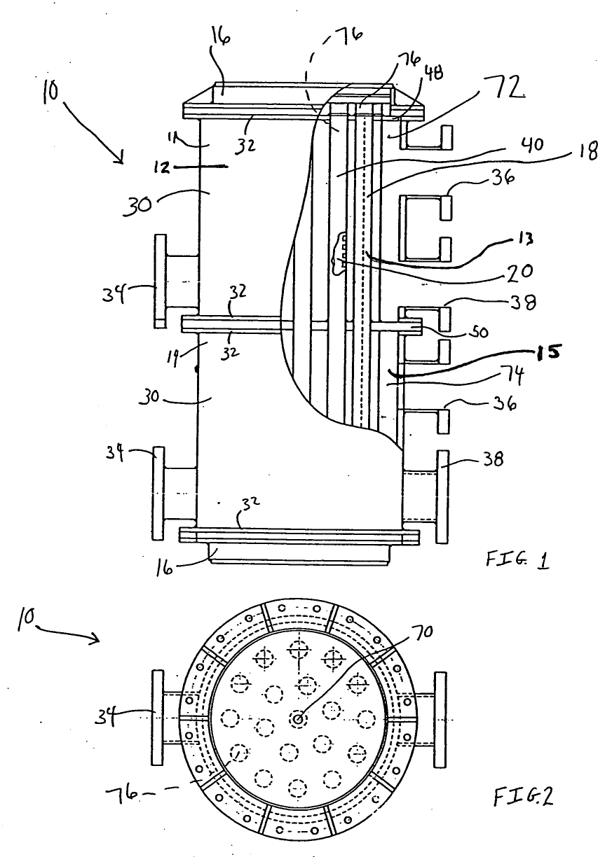

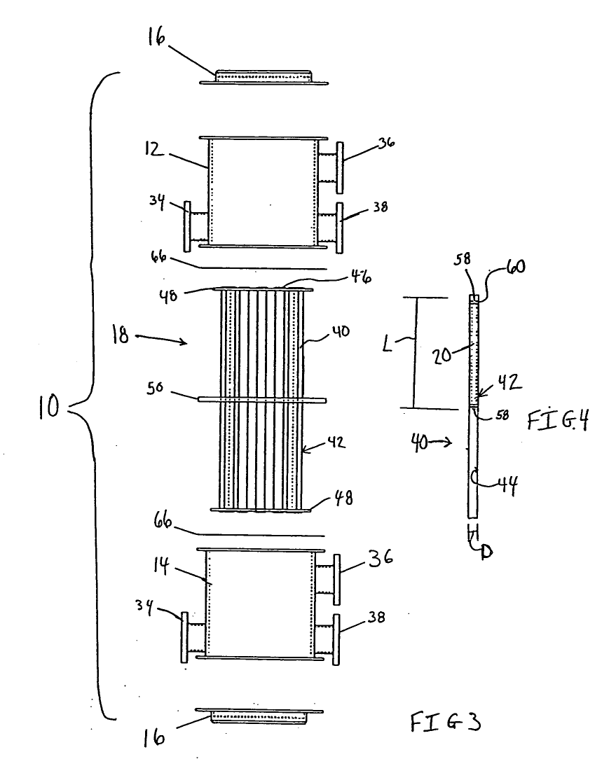

Referring to FIGS. 1 and 2, the magnetic filter 10 of the present invention is shown in a preferred embodiment to include a body formed of a top housing 12, a bottom housing 14, end caps 16, filter tube assembly 18, and magnet assemblies 20. Top housing 12 and bottom housing 14 are geometrically similar and include a generally cylindrical shell 30, mating flanges 32, inlet 34, outlet 36, and backwash port 38 which form oil holding chambers 13 and 15.

As best seen in FIG. 3, filter tube assembly 18 includes an array of magnet holding members in the form of hollow filter tubes 40 having an external surface 42 and an internal surface 44, and opposing ends 46. The external surface 42 defines a portion of the oil holding chambers. As explained below, the hollow filter tubes are preferably made of non-ferrous materials which allow the passage of magnetic flux into the oil to be cleaned. Filter tubes 40 are interconnected adjacent opposing ends 46 by tube sheets 48. Filter tubes 40 are also interconnected by a central tube plate 50. Tube sheets 48 and tube plate 50 are generally circular sheets that are provided with apertures 52 to accommodate filter tubes 40. Preferably, filter tubes 40 are circumferentially welded along external surface 42 to tube sheets 48 and tube plate 50.

Referring now to FIGS. 1 and 4, magnet assemblies 20 include a magnet portion 56 and end portions 58. Preferably, end portions 58 have a thrust seal 60 coupled thereon. Thrust seal 60 is adapted to sealingly contact internal surface 44 of filter tubes 40. Internal diameter D of filter tube 40 is adapted to accommodate the diameter of magnet portion 56. In this manner, thrust seals 60 are adapted to provide some resistance to relative movement between magnet assemblies 20 and filter tubes 40 while allowing magnet assemblies 20 to shuttle within filter tubes 40. While magnet assembly 20 can be manually shuttled within filter tube 40 using an actuation assembly, magnet assemblies 20 are preferably shuttled within filter tubes 40 with the use of a differential pneumatic pressure across thrust seal 60 as discussed below.

As best seen in FIGS. 1 and 2, tube plate 50 is interposed between housings 12 and 14 as filter tubes 40 are positioned within housings 12 and 14. Mating flanges 32 are bolted to tube plate 50 with gaskets 66 positioned therebetween although other coupling means may be employed. End caps 16 are coupled to mating flanges 32. Preferably, end caps 16 are provided with an access port 70. When assembled, top housing 12, end cap 16, and filter tube assembly 18 define a sealed top chamber 72; bottom housing 14, end cap 16, and filter tube assembly 18 define a sealed bottom chamber 74; and filter tube assembly 18 and end caps 16 define a magnet shuttle area 76 that includes the inside volume of filter tubes 40.

In operation, magnet assemblies 20 are preferably shuttled within filter tubes 40. This can be accomplished using mechanical mechanisms such as screw or cable driven actuators or the application of a pressurized source of air to access port 70 of one end cap 16 while allowing an escape of fluid through access port 70 of the opposite end cap 16. The length L of magnet assemblies 20 is preferably provided such that magnet assemblies 20 can be positioned within one housing 12, 14 while not exerting an appreciable magnetic force within the other housing 12, 14. In this regard, when the magnet assembly 20 is positioned in one housing, magnetic flux from the assembly passes through the hollow filter tube 40 and into the oil being cleaned. It would be appreciated that while FIG. 4 illustrates a single magnet assembly 20 in a filter tube 40, multiple magnet assemblies 20 can be employed within a single filter tube 40 to accomplish a similar result. It would also be appreciated that while FIG. 4 illustrates two thrust seals 60 coupled to magnet assembly 20, magnet assembly 20 can be provided with any number of thrust seals 60.

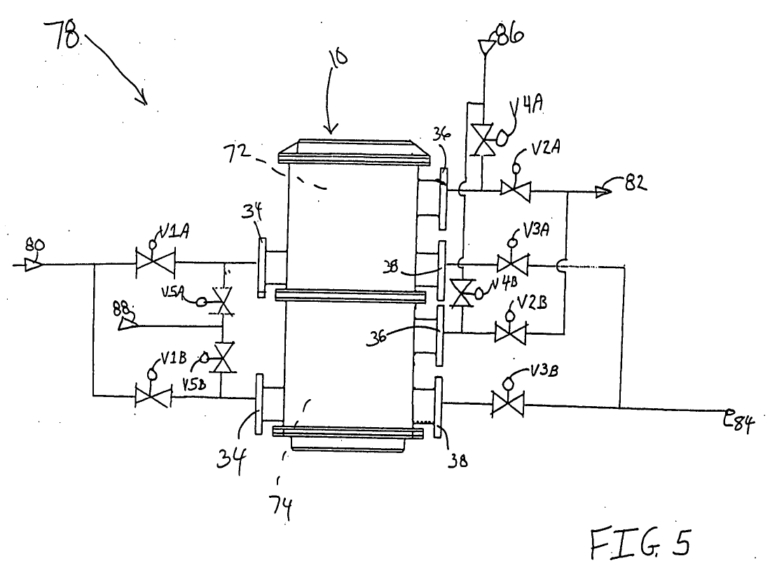

Referring now to FIG. 5, magnetic filter 10 is illustrated with a preferred piping arrangement defining a system 78 which includes a plurality of control valves. A valve V1A interconnects system inlet 80 in fluid communication with inlet 34 of top chamber 72. A valve V2A interconnects outlet 36 of top chamber 72 with a system outlet 82. A valve V3A interconnects backwash port 38 of top chamber 72 with a system waste port outlet 84. Valve V4A interconnects outlet 36 of top chamber 72 in fluid communication with a backwash connection 86. Valve V5A interconnects inlet 34 of top chamber 72 in fluid communication with backwash connection 86.

Similarly, valve V1B interconnects system inlet 80 in fluid communication with inlet 34 of bottom chamber 74. Valve V2B interconnects outlet 36 of bottom chamber 74 in fluid communication with system outlet 82. Valve V3B interconnects backwash port 38 of bottom chamber 74 in fluid communication with system waste outlet 84. Valve V4B interconnects outlet 36 of bottom chamber 74 in fluid communication with backwash connection 86 and valve V5B interconnects inlet 34 of bottom chamber 74 in fluid communication with backwash connection 86.

For filter mode operational setup of top chamber 72, magnet assemblies 20 are positioned within top chamber 72; valves V1B, V2B, V3A, V4A, and V5A are closed; and valves V1A, and V2A are open. A working fluid containing ferromagnetic particles is introduced into system inlet 80 with sufficient pressure to maintain fluid flow to system outlet 82. In this manner, the magnetic attractive force of magnet assemblies 20 cause at least a portion of the ferromagnetic particles to accumulate on external surface 42 of filter tubes 40 within top chamber 72. Thus provided, the working fluid flow is both transverse and aligned with the direction of filter tubes 40. Preferably, the working fluid is a cutting oil/cooling fluid emulsion although it would be envisioned that other fluids could be magnetically filtered with some degree of success. It would be appreciated that providing the inlet 34 at a lower elevation than outlet 36 would further promote the separation of heaver ferromagnetic particles from a cutting oil/cleaning fluid emulsion.

When top chamber 72 is in an operating or standby filter mode, bottom chamber 74 can be backwashed to remove the ferromagnetic particles that have accumulated therein from a previous filter mode operation. For backwash mode setup of bottom chamber 74, magnet assemblies 20 remain within top chamber 72 and valves V1B, V2B, V3A, V4A, V5A, V1A, and V2A remain in the valve positions indicated above. Valve V3B is open and a backwash fluid is introduced into bottom chamber 74 and allowed to drain through backwash port 38. In this manner, the backwash fluid transports the accumulated ferromagnetic particles from bottom chamber 74 to system waste outlet 84 or a recycle location. It would be envisioned that the backwash fluid can enter bottom chamber 74 through valve V3B, V4B, V5B, or some combination thereof. It would also be envisioned that the working fluid pressure at system inlet 80 may be sufficient to allow the working fluid to enter through valve V1B and serve as the backwash fluid.

Thus provided, magnetic filter 10 can filter ferromagnetic particles from a working fluid within a top chamber 72 when magnet assemblies 20 are positioned within top chamber 72 while bottom chamber 74 is backwashed. The flow of the working fluid can be re-routed to flow through bottom chamber 74 as magnet assemblies 20 are positioned within bottom chamber 74 to provide a continuous filtering capability with a sealed magnetic filter 10 without the need to shut down system 78 filtering operations to backwash the filtering chamber. It would be appreciated that the magnetic filters disclosed herein could be modified to include three or more chambers with a plurality of magnet assemblies to allow for filtering and/or backwashing simultaneously in more than one chamber. Further it is envisioned that the magnet assembly can take the form of a plurality of discreet magnetic members such as spherical balls.

The description of the invention is merely exemplary in nature and, thus, variations that do not depart from the gist of the invention are intended to be within the scope of the invention. For example, while the system shows the shuttling of magnetic materials is used to remove or reduce the magnetic flux in the oil, it is equally envisioned that materials can be interposed between the magnets and the oil within the hollow tubes to disrupt the magnetic flux. It is envisioned ferrous materials or a family of alloys known as mu metals can be used. Additionally, while metal magnetic bars are shown, it is envisioned that magnets can take any shape or can be electromagnets. Such variations are not to be regarded as a departure from the spirit and scope of the invention.

What is claimed is:

1. A filter for removing ferrous material from oil comprising:
a body defining a first oil holding chamber;
a first surface defining a portion of the first oil holding chamber; and
a magnetic member selectively disposable in proximity to the first surface so as to allow magnetic flux lines pass though the first surface into the first oil chamber, wherein the magnetic flux lines function to draw the ferrous metal from the oil into a position adjacent the first surface.

2. The filter according to claim 1 comprising a first and second magnetic location, said first location being adjacent to the first surface.

3. The filter according to claim 2 wherein when the magnet is in the second magnetic location the magnetic flux is not sufficient to draw the ferrous material to the position adjacent the first surface.

4. The filter according to claim 1 wherein the body further defines a plurality of magnet holding members, said magnetic holding members defining a portion of the chamber.

5. The filter according to claim 4 wherein the magnetic holding members define a plurality of cylindrical chambers configured to hold a plurality of magnets.

6. The filter according to claim 5 wherein the cylindrical chambers are fluidly separate from the first oil holding chamber.

7. The filter according to claim 6 comprising a plurality of magnets which are selectively removable from the cylindrical chambers.

8. The filter according to claim 1 comprising a means for backwashing the first chamber.

9. The filter according to claim 1 wherein the first chamber defines an first input port coupled to a dirty oil supply and an output port coupled to a cleaned oil supply.

10. The filter according to claim 9 wherein the body defines a second oil holding chamber, said second oil holding chamber having a second surface defining a portion of the second oil holding chamber.

11. The filter according to claim 10 wherein a magnetic member is selectively disposable in proximity to the second surface so as to allow magnetic flux lines pass though the second surface into the second oil chamber, wherein the magnetic flux lines function to draw the ferrous metal from the oil into a position adjacent the second surface.

12. The filter according to claim 11 wherein the second chamber defines an second input port coupled to the dirty oil supply and a second output port coupled to the cleaned oil supply.

13. The filter according to claim 12 further comprising a valve configured to regulate flow of dirty oil from the first input port to the second input port.

14. A filter for removing ferrous material from oil comprising:
a body defining a first oil holding chamber and a second oil holding chamber;
a first surface defining a portion of the first oil holding chamber;
a magnetic member selectively movable from a first location to a second location, said first location is in proximity to the first surface so as to allow magnetic flux lines pass though the first surface into the first oil chamber, wherein the magnetic flux lines function to draw the ferrous metal from the oil into a position adjacent the first surface; and
a mechanism to move the magnetic member from the first position to the second position.

15. The filter according to claim 14 wherein when the magnet is in the second magnetic location the magnetic flux is not sufficient to draw the ferrous material to the position adjacent the first surface.

16. The filter according to claim 14 wherein the body further defines a plurality of magnet holding members, said magnetic holding members defining a portion of the chamber.

17. The filter according to claim 16 wherein the magnetic holding members define a plurality of cylindrical chambers configured to hold a plurality of magnets.

18. The filter according to claim 17 comprising a plurality of magnets, each magnet being selectively removable from a cleaning position to a backwashing position.

19. The filter according to claim 18 further comprising a valve configured to regulate flow of incoming dirty oil from entering the first oil holding chamber to the second oil holding chamber.

20. A filter for removing ferrous material from oil comprising:
a body defining a first oil holding chamber and a second oil holding chamber;
a magnetic member selectively movable from a first location to the second location;
a first surface defining a portion of the first oil holding chamber, said first location being in proximity to the first surface so as to allow magnetic flux lines from the magnetic member pass though the first surface into the first oil chamber, wherein the magnetic flux lines function to draw the ferrous metal from the oil into a position adjacent the first surface;
a second surface defining a portion of the second oil holding chamber said first location being in proximity to the first surface so as to allow magnetic flux lines pass though the first surface into the first oil chamber, wherein the magnetic flux lines function to draw the ferrous metal from the oil into a position adjacent the first surface; and
a mechanism to move the magnetic member from the first position to the second position.

21. The filter according to claim 20 wherein the body further defines a plurality of magnet holding members, said magnetic holding members defining a portion of the first oil holding chamber.

22. The filter according to claim 21 wherein the body further defines a plurality of magnet holding members, said magnetic holding members defining a portion of the second oil holding chamber.
